(19) United States
(12) Patent Application Publication
(10) Pub. No.: US 2009/0004941 A1
(43) Pub. Date: Jan. 1, 2009

(54) Bio-disintegratable board comprising polyactic acid conjugate fiber and natural fiber and its preparation method

(75) Inventors: Dae Sik Kim, Suwon-si (KR); Choon Soo Lee, Seoul (KR)

Correspondence Address: EDWARDS ANGELL PALMER & DODGE LLP, P.O. BOX 55874, BOSTON, MA, 02205, US

(73) Assignee: Hyundai Motor Company, Seoul (KR)

(21) Appl. No.: 11/978,029

(22) Filed: Oct. 25, 2007

(30) Foreign Application Priority Data
Jun. 27, 2007 (KR) 10-2007-0063595

(51) Int. Cl. D04H 13/00; B32B 37/14

(52) U.S. Cl. 442/334; 156/60

(57) ABSTRACT

The present invention relates to a biodegradable board comprising laminates of nonwoven fabric, which comprises natural fiber and a sheath-core type composite fiber having double layers of inner part and surface layer and its preparation method, and particularly to a biodegradable board comprising at least two layers of nonwoven fabric, which comprises natural fiber and sheath-core type composite fiber comprising biodegradable polylactic acid as a sheath component and resins such as polyethyleneterephthalate, polypropylene and polyethylene as a core component, and its preparation method.

### CROSS-REFERENCE TO RELATED APPLICATION

This application claims the benefit under 35 U.S.C. §119(a) on Korean Patent Application No. 10-2007-0063595 filed on Jun. 27, 2007, entire contents of which are incorporated herein by reference.

### TECHNICAL FIELD

The present invention relates to a bio-disintegratable board for use in vehicles and a method for preparing the board. More particularly, it relates to a bio-disintegratable board comprising at least two layers of nonwoven fabric which comprises a natural fiber and a sheath-core type conjugate fiber.

### BACKGROUND ART

Due to the change in regulations, social concerns and recognitions regarding environment, eco-friendly material has been increasingly drawing attention. The concept of a recycling material has been emphasized since the end of the 20^{th} century, and as a result, many companies in advanced countries have been attempting to replace petroleum with an eco-friendly material based on a natural material or agricultural products.

Biocomposites are generally matrix and comprise a biofiber or a natural fiber as a reinforcing fiber as well as a biodegradable polymer. Biocomposites are also biodegradable because the two main components are biodegradable. Many automobile companies are competitively exerting extensive researches to apply biodegradable materials to vehicle parts. Those biodegradable materials have various advantages in connection with the exhaustion of petroleum resources, the regulation of recycling rate and the reduction of carbon dioxide and volatile organic materials.

Biodegradable polymer is much expensive compared to conventional polymers, and is usually blended with low-priced non-degradable polymer for use. The biodegradable polymer remarkably decreases the degradation time of the non-degradable polymer, which is referred to herein as “bio-disintegratable”.

Polylactic acid known as biodegradable polymer matrix for biocomposites has limitation in application due to high manufacturing cost in spite of superior mechanical and biodegradable properties.

The above information disclosed in this Background section is only for enhancement of understanding of the background of the invention and therefore it may contain information that does not form the prior art that is already known in this country to a person of ordinary skill in the art.

### SUMMARY

The present inventors have exerted extensive researches and finally developed a bio-disintegratable board that can overcome the above-described problems associated with prior art, and a method for preparing the bio-disintegratable board.

The present bio-disintegratable boards comprise a natural fiber and a sheath-core type conjugate fiber comprising polylactic acid as a sheath component. As compared to the conventional polylactic acid fiber having a singular structure, such bio-disintegratable board shows improved mechanical and thermal properties and enables a remarkable decrease in manufacture cost, which enables the present bio-disintegratable boards to be applied to various interior furnishings of a vehicle.

In one aspect, the present invention provides a bio-disintegratable board comprising at least two layers of nonwoven fabric, which comprises a sheath-core type conjugate fiber and a natural fiber, wherein the sheath-core type conjugate fiber comprises 30-70 wt % of polylactic acid as a sheath component and 30-70 wt % of a resin selected from the group consisting of polyethyleneterephthalate, polytrimethyleneterephthalate, polypropylene and polyethylene as a core component.

In another aspect, the present invention provides a process for preparing a bio-disintegratable board by laminating nonwoven fabric comprising a sheath-core type conjugate fiber and a natural fiber, wherein the sheath-core type conjugate fiber comprises 30-70 wt % of polylactic acid as a sheath component and 30-70 wt of a resin selected from the group consisting of polyethyleneterephthalate, polypropylene and polyethylene as a core component.

In a preferred embodiment, the method may further comprise the steps of: pressing the nonwoven fiber at 180-210° C. by using a press; and maintaining the temperature of the press within the range of 100-120° C. for 5-15 minutes.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like. The present bio-disintegratable boards and methods for preparing the same will be particularly useful with a wide variety of motor vehicles.

Other aspects of the invention are discussed infra.

### BRIEF DESCRIPTION OF DRAWINGS

FIG. 1 shows a conventional singular polylactic acid fiber and a sheath-core conjugate fiber according to an embodiment of the present invention.

### DETAILED DESCRIPTION

Reference will now be made in detail to the preferred embodiment of the present invention, examples of which are illustrated.

As used herein, the term “bio-disintegratable board” refers to a board, a panel or a processed product prepared by using a biodegradable material and has a relatively wider area as compared to thickness, which can be applied to, for example, interior furnishings of a vehicle.

As used herein, the term “bio-disintegratable” refers to degradable due to the activity of microorganisms such as bacteria, fungi and algae, which differs from “100% biodegradable” in that “bio-disintegratable” herein needs a relatively longer time for degradation.

As used herein, “nonwoven fabric” refers to a nonwoven fiber, which has an interlaid structure and a relatively wider area compared to the thickness.

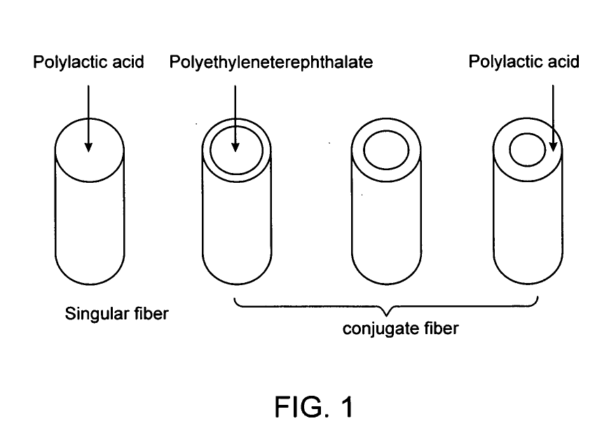

A sheath-core conjugate fiber according to a preferred embodiment of the present invention is illustrated in FIG. 1. As a sheath component, polylactic acid is contained 30-70 wt % of the sheath-core type conjugate fiber, thereby causing the biodegradable property of the board herein. A resin such as polyethyleneterephthalate, polytrimethyleneterephthalate, polypropylene and polyethylene, preferably polyethyleneterephthalate may be used as a core component. The core component is contained 30-70 wt % of the sheath-core type conjugate fiber, thus remarkably increasing mechanical or thermal properties and economic efficiency as compared to the conventional biodegradable board prepared using polylactic acid fiber.

A sheath component and a core component, which constitute the sheath-core conjugate fiber, may further comprise other additives that do not adversely affect the desired properties of the conjugate fiber. Examples of such additives include a pigment, an antioxidant, a stabilizer, a surfactant, a wax, a flow agent a solid solvent and a particular material. Such additives may be contained less than 5 wt %, preferably 1 wt % of the sheath-core conjugate fiber.

A sheath-core type conjugate fiber herein may be prepared according to any conventional process without limitation, where a sheath component and a core component are spun, respectively, instead of being pre-mixed. For example, polymer fibers are combined in a spinneret hole comprising two or more concentrically circular holes or a circular spinneret hole divided into two parts along the diameter to provide a side-by-side type fiber. The combined polymer fiber is then cooled, solidified and drawn, generally by a mechanical rolls system, to an intermediate fiber diameter and collected. Subsequently, the filament may be cold-drawn, at a temperature below its softening temperature, to a desired final fiber diameter, and can be cut into desired lengths by crimping or weaving the fiber.

Various natural fibers such as jute, sisal, bamboo, coconut, hemp and flax may be used as a natural fiber herein. Among them, kenaf fiber is preferred considering its high mechanical properties, stable supply due to sufficient production and its superior activity of reducing carbon dioxide.

Besides the natural fiber and the sheath-core conjugate fiber, at least one kind of singular fiber prepared by using resins such as polypropylene and polyethyleneterephthalate may be additionally be contained for the preparation of the nonwoven fabric herein in the amount of less than 40 wt %.

The weight ratio of the natural fiber and the sheath-core conjugate fiber ranges from 4:6 to 8:2, preferably from 5:5 to 7:3, and more preferably 6:4.

For the preparation of the bio-disintegratable board herein, nonwoven fabric is prepared by mixing sheath-core conjugate fiber and natural fiber, optionally together with singular fiber prepared using a resin such as polypropylene and polyethyleneterephthalate in an appropriate ratio. The method for preparing nonwoven fabric includes, but not limited to, a carding method.

Bio-disintegratable board is prepared by laminating and pressing from several to tens of layers of nonwoven fabric for controlling areal density and thickness.

During the pressing process, pressure and temperature are preferred to be maintained with 500-700 ton·f/m² and 180-210° C. (preferably 200° C.), respectively. Such ranges are advantageous to the improvement of properties and the prevention of smell.

After pressing process, the pressing temperature is lowered to 100-120° C. at a rate of 5° C./minute, and maintained at that temperature for 5-15 minutes, while maintaining the initial pressure. The crystallinity of polylactic acid depends on such time and temperature. When the temperature is higher than 120° C. or is decreased too rapidly, high crystallinity may not be obtained. High crystallinity is advantageous to the improvement of thermal properties.

### EXAMPLES

The present invention is described more specifically by the following Examples. Examples herein are meant only to illustrate the present invention, but they should not be construed as limiting the scope of the claimed invention.

### Example 1

Composite fiber was prepared by incorporating polyethyleneterephthalate as a core component and polylactic acid (NatureWorks LLC) as a sheath component in the weight ratio of 3:7. Nonwoven fabric was prepared according to the carding method by mixing the composite fiber with diameter of 20˜40 μm and a natural fiber (kenaf fiber) in the weight ratio of 6:4. Bio-disintegratable board was prepared by appropriately laminating the nonwoven fabric so that a desired value of areal density may be obtained.

### Example 2

Bio-disintegratable board was prepared in a manner same as in Example 1 except that conjugate fiber containing polyethyleneterephthalate and polylactic acid in the weight ratio of 5:5 was used instead of the composite fiber containing polyethyleneterephthalate and polylactic acid (NatureWorks LLC) in the weight ratio of 3:7.

### Example 3

Bio-disintegratable board was prepared in a manner same as in Example 1 except that conjugate fiber containing polyethyleneterephthalate and polylactic acid in the weight ratio of 7:3 was used instead of the composite fiber containing polyethyleneterephthalate and polylactic acid (NatureWorks LLC) in the weight ratio of 3:7.

### Example 4

Bio-disintegratable board was prepared in a manner same as in Example 2 except that the temperature was lowered down to 100° C. and maintained for 5, 10 and 15 minutes.

### Comparative Example 1

Biodegradable board was prepared by mixing the conventional polylactic acid having a singular structure and the natural fiber in the weight ratio of 6:4. This biodegradable board was used in the tests described below after being cooled at room temperature for preventing the crystallization. The results are provided in Tables 1 and 2.

### [Test Method]

Tensile strength and elongation were measured by conducting tensile tests at room temperature according to ASTM D 638 (Standard Test Method for Tensile Properties of Plastics) using a universal testing machine (Tensile strength[Pa]=Maximum load[N]/Initial cross section of specimen[m²]; Elongation[%]=Elongation at break/Initial length).

HDT (Heat Distortion Temperature) was measured according to ASTM D648 (Load per unit length=16.8 kgf/cm).

TABLE 1

| | Tensile strength | HDT |
|---|---|---|
| Example 1 | 24.6 MPa | 80° C. |
| Example 2 | 28.5 MPa | 86° C. |
| Example 3 | 31.2 MPa | 95° C. |
| Comp. Ex. 1 | 21.0 MPa | 78° C. |

TABLE 2

| | Crystallization | | | |
|---|---|---|---|---|
| | time | Tensile strength | HDT | Crystallinity |
| Example 4 | 5 minutes | 25.9 MPa | 90° C. | 15.2% |
| | 10 minutes | 28.2 MPa | 96° C. | 20.5% |
| | 15 minutes | 30.8 MPa | 104° C. | 35.2% |

As shown in Table 1, tensile strength and HDT are gradually improved as the content of polyethyleneterephthalate increases. As shown in Table 2, tensile strength and HDT are also improved as crystallization time increases.

As described above, the present invention adopts a relatively low-priced polyethyleneterephthalate instead of using an expensive polylactic acid singular fiber. Nevertheless, mechanical properties are remarkably improved when compared to the polylactic acid singular fiber. Therefore, a bio-disintegratable board of the present invention may be applied to various industrial fields such as interior furnishings of a vehicle.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A bio-disintegratable board for use in a vehicle comprising at least two layers of nonwoven fabric, wherein said nonwoven fabric comprises a sheath-core type conjugate fiber and a natural fiber.

2. The bio-disintegratable board of claim 1, wherein the sheath-core type conjugate fiber comprises 30-70 wt % of polylactic acid as a sheath component, and 30-70 wt % of a resin selected from the group consisting of polyethyleneterephthalate, polytrimethyleneterephthalate, polypropylene and polyethylene as a core component.

3. The bio-disintegratable board of claim 1, wherein said nonwoven fabric further comprises at least one resin selected from the group consisting of polypropylene and polyethyleneterephthalate.

4. The bio-disintegratable board of claim 1, wherein said core component is polyethyleneterephthalate.

5. The biodegradable board of claim 1, wherein said natural fiber is kenaf fiber.

6. A process for preparing a bio-disintegratable board of claim 1, the process comprising the steps of:
(a) providing a nonwoven fabric by mixing a sheath-core type conjugate fiber and a natural fiber; and
(b) laminating said nonwoven fabric.

7. The process of claim 6, wherein the sheath-core type conjugate fiber comprises 30-70 wt % of polylactic acid as a sheath component, and 30-70 wt % of a resin selected from the group consisting of polyethyleneterephthalate, polytrimethyleneterephthalate, polypropylene and polyethylene as a core component.

8. The process of claim 6, further comprising the step of adding at least one resin selected from the group consisting of polypropylene and polyethyleneterephthalate to prepare the nonwoven fabric.

9. The process of claim 6, wherein said core component is polyethyleneterephthalate.

10. The process of claim 6, wherein said natural fiber is kenaf fiber.

11. The process of claim 6, further comprising the steps of pressing said nonwoven fiber at a predetermined temperature by using a press; and maintaining the temperature of the press within a predetermined temperature range for a predetermined time.

12. A process for preparing a bio-disintegratable board, comprising the steps of:
(a) providing a nonwoven fabric by mixing a sheath-core type conjugate fiber and a natural fiber, wherein said sheath-core type composite fiber comprises 30-70 wt % of polylactic acid as a sheath component and 30-70 wt of a resin selected from the group consisting of polyethyleneterephthalate, polypropylene and polyethylene as a core component;
(b) laminating said nonwoven fabric;
(c) pressing said laminated nonwoven fiber at 180-210° C. by using a press; and
(d) maintaining the temperature of the press within 100-120° C. for 5-15 minutes.
